(19) United States
(12) Patent Application Publication
(10) Pub. No.: US 2025/0208850 A1
(43) Pub. Date: Jun. 26, 2025

(54) REMOTE TERMINAL DEVICE UPDATES

(71) Applicant: PayPal, Inc., SAN JOSE, CA (US)

(72) Inventors: Cory Monty, San Jose, CA (US); Martin Wojcik, Cedar Park, TX (US)

(21) Appl. No.: 18/394,941

(22) Filed: Dec. 22, 2023

(51) Int. Cl. G06F 8/65; G06F 8/71

(52) U.S. Cl. CPC G06F 8/65; G06F 8/71

(57) ABSTRACT

A method for remote device updates includes receiving a selection of a terminal device having an existing operational configuration and capable of operating in a development mode and a production mode. The method further includes receiving a new operational configuration for the terminal device, causing the terminal device to enter development mode with the new operational configuration, receiving an indication that the new operational configuration should be deployed, and, in response to the indication, formatting the new operational configuration into one or more files usable by the terminal in production mode, and causing the one or more files to be transmitted to the terminal with an instruction for the terminal device to enter production mode operating according to the one or more files.

### TECHNICAL FIELD

This disclosure relates to updates for electronic devices, including remote updates for configuration files in electronic devices, such as terminal devices.

### BACKGROUND

User-facing electronic devices, such as payment terminals and other electronic transaction terminals, utilize configuration files that define settings for various aspects of the device's operation. For example, one or more configuration files may be used by a terminal device to define the display output, such as images used, fonts, font sizes, text, arrangement of elements, etc. Configuration files may also be used to define aspects of a communications protocol, security protocol, and other operational settings.

### BRIEF DESCRIPTION OF THE DRAWINGS

FIG. 1A is a block diagram view of an example system for remote configuration of terminal devices, including network directory storage of configuration files.

FIG. 1B is a block diagram view of a portion of the system of FIG. 1A.

FIG. 2 is a block diagram view of an example workstation for use in the system of FIG. 1A, including local storage of configuration files.

FIG. 3 is a perspective view of an example terminal device.

FIG. 4 is a block diagram view of the system of FIG. 1A, illustrating additional functionality of various components of the system.

FIG. 5 is a block diagram view of the system of FIG. 1A, illustrating additional functionality of various components of the system.

FIG. 6 is a block diagram view of an example terminal device for use with a remote configuration system.

FIG. 7 is a flow chart illustrating an example computer-implemented method of performing remote device updates from a workstation.

FIG. 8 is a flow chart illustrating an example computer-implemented method of performing remote device updates by a server.

FIG. 9 is a flow chart illustrating an example computer-implemented method of receiving remote device updates by a terminal device.

FIG. 10 is a flow chart illustrating an example computer-implemented method of performing remote device updates with a server.

FIG. 11 is a flow chart illustrating an example computer-implemented method of performing remote device updates with a workstation.

FIG. 12 is a flow chart illustrating an example computer-implemented method of receiving remote device updates by a terminal device.

FIG. 13 is a block diagram of an example computing system.

### DETAILED DESCRIPTION

In past operation, terminal devices such as electronic transaction terminals received updates to stored configuration files by wired connection upload of a new executable or binary file. As a result, device updates can be time-consuming, because replacement of an existing executable or binary with a new version can occupy the processing and memory resources of the device for a considerable amount of time. Further, generating the binary or executable file, after making desired changes to a configuration file in an editor, in the first instance can be time-consuming. Still further, such an approach to updates requires distribution of physical storage media (e.g., a thumb drive containing the new binary or executable) to perform an update, making updates to devices deployed in their field of use difficult and slow.

Terminal device updates according to the present disclosure improve upon known methods of performing updates by providing, first, approaches that enable updates of terminal devices via remote network connection, thus eliminating the need to distribute physical media for updates. Second, updates may be performed through transmission and updating of the configuration file(s) only, in some embodiments, instead of transmission and updating of a binary or executable file, thus causing both the generation of the update file and the installation of the update file to be faster relative to known approaches. Third, updates may be performed via a development mode of the terminal device, which executes independently of the main operation production mode of the terminal device, enabling an environment on the terminal device in which configurations may be tested without unduly affecting the main functionality of the terminal device.

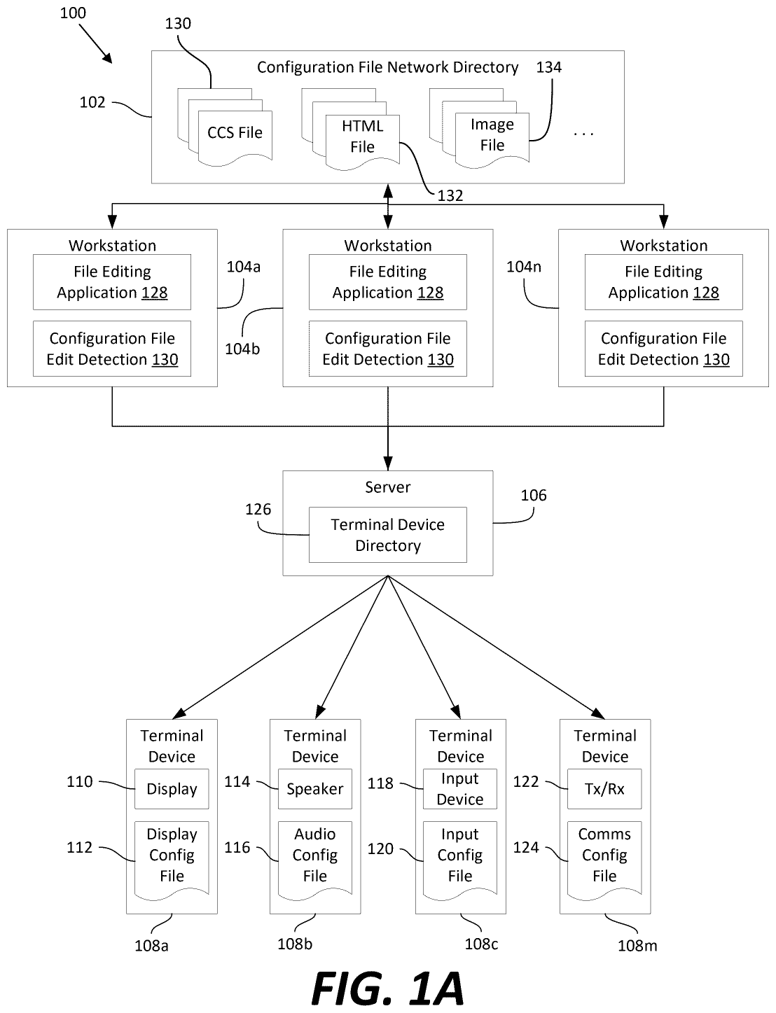

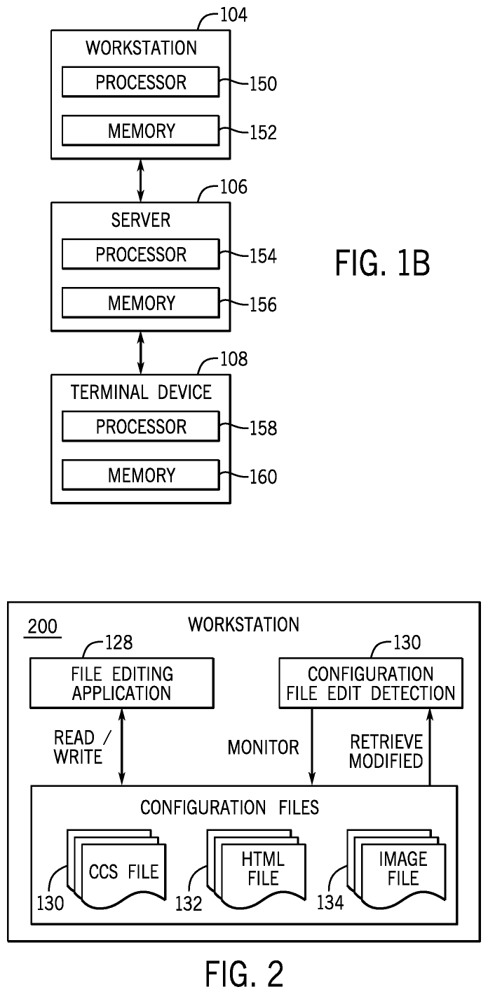

Referring to the drawings, wherein like numerals refer to the same or similar features in the various views, FIG. 1A is a block diagram view of an example system 100 for performing remote updates for terminal devices. The system 100 may include a configuration file network directory 102, one or more workstations 104a, 104b, . . . 104n (which may be referred to collectively as the workstations 104 or individually as a workstation 104), a server 106, and a plurality of terminal devices 108a, 108b, 108c, . . . 108m (which may be referred to collectively as the terminal devices or terminals 108 or individually as a terminal device or terminal 108).

Each terminal device 108 may include one or more configuration files and one or more configurable aspects or components. Although each terminal device 108 may include partially or entirely overlapping configurable aspects or components as each other terminal device 108, each terminal device 108 is illustrated with a unique configurable aspect or component, for ease of illustration and description.

The first terminal device 108a may include a display 110 and a display configuration file 112. The display 110 may be or may include an LCD, LED, segment, or other appropriate display technology. The display configuration file 112 may be or may include one or more configuration files, such as HTML files, CSS files, and/or image files. The display configuration files may include settings and information utilized by a display operation application. For example, the display configuration file may include text content, size, and arrangement, image size, scaling, and arrangement, and the like.

The second terminal device 108b may include a speaker 114 and an audio configuration file 116. The speaker 114 may be of any appropriate size or driver technology. The audio configuration file 116 may be or may include, for example, settings and information used in audio output, such as an audio file, tone, volume, frequency, etc.

The third terminal device 108c may include an input device 118 and an input configuration file 120. The input device 118 may be or may include, for example, one or more buttons, a keyboard, a mouse, a joystick, and/or another appropriate user input device. The configuration file 120 may be or may include one or more files containing settings for the input device, such as the functionality triggered when a button is pressed, the language or key layout of a keyboard, the sensitivity of a mouse or joystick, etc.

The fourth terminal device 108m may include a transmitter/receiver (labeled as a tx/rx) 122 and a communications configuration file 124. The transmitter/receiver 122 may transmit and/or receive data over any appropriate communications channel and/or protocol, and may include any hardware needed to effect such transmit and/or receive functionality. The communications configuration file 124 may be or may include one or more files containing transmitting and/or receiving settings, such as protocol settings, encryption settings, a transmission frequency, address of a recipient for a transmission, and other relevant settings.

Each of the terminal devices 108 may be deployed, or may be intended to be deployed, in a particular use, setting, location, etc. to conduct computing transactions. In some embodiments, a respective one or more terminal devices 108 (e.g., a plurality of terminal devices 108) may be deployed at each respective locations of a plurality of locations. Though separately deployed or intended to be deployed, a plurality of such terminal devices 108 may be co-located for a common configuration process, in some embodiments. In other embodiments, configuration of a terminal device 108 may occur while the terminal device is deployed in its intended deployment location.

Each terminal device 108 may be a respective computing transaction terminal, in some embodiments. For example, one or more terminal devices 108 may be user-facing payment terminals or point-of-sale terminals, in some embodiments. Additionally or alternatively, one or more terminal devices 108 may be security terminals (e.g., for receiving user access credentials to secure a facility, device, etc.). Additionally or alternatively, one or more terminal devices 108 may be informational user interface devices, such as a building directory, an elevator information panel or call button panel, and the like. Each terminal device 108 may be any network-connectable device having one or more configurable operational settings.

The terminal devices 108 may be in electronic communication with the server 106. In some embodiments, communication between the server 106 and a terminal device 108 may be solely for the purposes of distributing updates to the terminal device 108. In other embodiments, the server 106 and terminal device 108 may additionally communicate for other purposes (e.g., for electronic transactions initiated at an electronic terminal 108 to be processed, or to transmit other data).

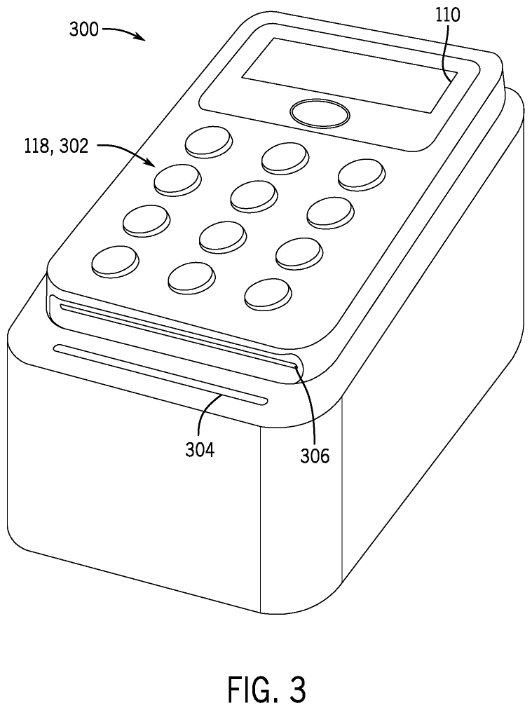

FIG. 3 illustrates an example terminal device 300, which is an example embodiment of terminal device 108. In the example of FIG. 3, the terminal device 300 is a payment terminal. The terminal device 300 includes a display 110 that may operate according to one or more display configuration files 112 (see FIG. 1A). For example, the display configuration files 112 may define the font, layout, content, color, interface progression, etc. of the display 110. The terminal device 300 may further include an input device 118 in the form of a keypad 302 that may operate according to one or more input configuration files 120 (see FIG. 1A). For example, the input configuration files 120 may define the button sensitivity, backlight color, and/or functionality in response to a user press of one or more of the buttons of the keypad 302. The terminal device 300 may further include one or more other input and output devices, such as an indicator light 304 and a card reader 306. Both the indicator light 304 and the card reader 306 may operate according to respective configuration files. For example, the configuration files for the indicator light 304 may define the output light color, brightness, pattern, etc. in response to particular inputs. The configuration files for the card reader 306 may define, for example, reader sensitivity for tap-to-pay, other near-field communications (NFC), or other touchless communications, enable or disable one or more communications or payment modes (e.g., enabling or disabling chip reading, tap-to-pay, etc.), and/or other settings.

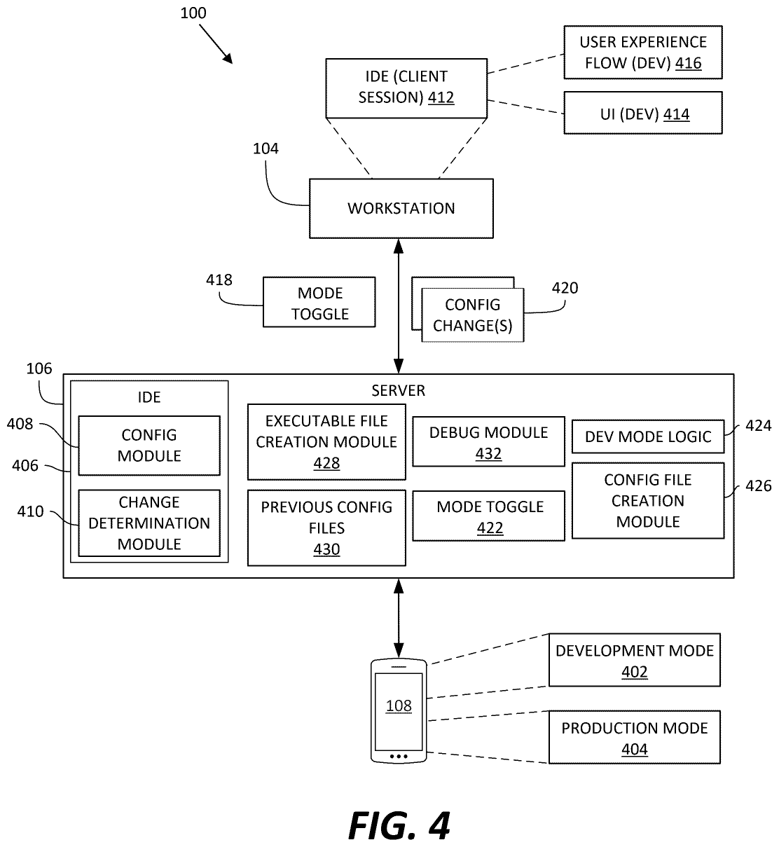

Referring again to FIG. 1A, the server 106 may include a terminal device directory 126 that includes a cross-reference of identifiers and addresses for each terminal device 108. Accordingly, the server 106 may receive operational configuration revisions and an associated terminal device identifier, and may communicate with the terminal device 108 according to the associated address to propagate the revisions. In some embodiments, the server 106 may have additional functionality, as will be described with respect to FIGS. 4, 5, and 6. For example, the server 106 may host a development environment in which a user of the workstation 104 may enter configuration changes, may determine differences between an existing and a new configuration, generating configuration files, generating executable files, and the like. In some embodiments, the server 106 may receive operational configuration revisions when the workstation pushes those revisions, such as by saving a file to storage or otherwise instructing the server 106 to propagate the revisions to a terminal device 108 (e.g., through the development environment).

The server 106 may open a connection to a terminal device 108 in response to a developer's identification of the terminal device 108 on a workstation 104. Such a connection may be a websocket or other persistent connection, for example. A persistent connection may advantageously enable the server 106 to automatically and immediately transmit configuration files to the terminal device 108 when received from a workstation without needing to reestablish a connection for each update transmission.

The workstations 104 may each be in electronic communication with the server 106 and with the configuration file network directory 102. Each workstation may be accessible to a user, such as an application developer, interface developer, etc. for altering the operational configuration of one or more terminal devices 108. Each workstation 104 may include a file editing application 128 and a configuration file edit detection application 130. The file editing application 128 may be separate from—i.e., running according to a separate executable from—the configuration file edit detection application 130, in some embodiments.

The file editing application 128 may be or may include any application for editing any type of file that may set the operational configuration of a terminal device. Such files may be, for example, CCS files 132, HTML files 134, image files 136, audio files, and/or YAML files for user interface configurations, and accordingly the file editing application 128 may be an editor for one or more of CSS, HTML, image, and/or audio files. For other types of configuration files and different types of operational configurations, different editors may be used or included in the file editing application 128. Accordingly, it should be understood that the operational configuration files are not limited to the file types explicitly listed in this disclosure, but instead may include any file that defines a setting of any operational aspect of the terminal device 108, including but not limited to the display, audio output, input devices, security settings, and the like. The file editing application may receive input from the user (e.g., a developer) to alter the operational configuration of a terminal device 108. The user's input may be revisions to an existing operational configuration file, creation of a new operational configuration file, or creation or editing of a template, document, etc. that can be converted or translated into an operational configuration file.

The configuration file edit detection application 130 may detect changes to one or more operational configuration files and, when changes are detected, may cause those changes to be propagated to one or more desired terminal devices 108. In some embodiments, the configuration file edit detection application 130 may receive an indication of one or more terminal devices 108 from the user (e.g., a developer) and may automatically direct subsequent detected configuration file changes to the indicated one or more terminal devices 108.

The configuration file edit detection application 130 may detect changes to one or more operational configuration files by monitoring a store of configuration files (e.g., the configuration file network directory). In some embodiments, the configuration file edit detection application 130 may determine that an operational configuration file has been newly saved and, in response, automatically propagate that configuration file, or one or more of its aspects, to an indicated terminal device. In some embodiments, the configuration file edit detection application 130 may additionally receive a selection of one or more configuration file types, names, etc. and may monitor for and automatically propagate changes to such files.

The configuration file network directory 102 may be accessible via network connection to a plurality of workstations 104. A plurality of configuration files may be stored in the configuration file network directory 102. For example, a plurality of user interface configuration files may be stored, such as one or more CCS files 132, one or more HTML files 134, and/or one or more image files 136. Each file may be associated with various metadata such as a file type, file extension, creation date, edit date, file source (e.g., a user or device that instructed its creation or edit), etc. Such metadata may be monitored, as described herein, to determine when updates occur in order to propagate those updates to one or more terminal devices 108. Accordingly, each workstation 104 may upload files to and read files from the configuration file network directory 102, as well as monitor the configuration file network directory 102 for file updates.

In operation, a developer user may use a workstation 104 (e.g., workstation 104a). The developer user may enter, on the configuration file edit detection application 130, a respective identifier of one or more terminal devices 108 to which subsequent configuration updates should be propagated. The configuration file edit detection application 130 may also receive, from the developer user, an identification of one or more file types or other file metadata for which the configuration file edit detection application 130 should monitor for configuration file revisions. The user may then enter one or more operational configuration changes through one or more file editing applications 128 and may save (e.g., as new files or as updated versions of existing files) the one or more operational configuration changes to the configuration file network directory 102. Such saves may be instructed by the file editing applications 128. The workstation 104a (e.g., the configuration file edit detection application 130) may monitor the configuration file network directory 102 for file updates matching the file metadata identified by the developer user and, when a file save matching that metadata is detected, the configuration file edit detection application 130 may retrieve that file from the configuration file network directory 102 and transmit it to the server along with the one or more terminal device identifies provided by the developer user. In turn, the server 106 may determine the addresses to the one or more terminal devices associated with the identifiers and transmit the updated configuration files to those addresses.

The update process outline above advantageously permits device updates to be performed remotely, and with the exchange of only configuration files, rather than the exchange of full binary files or wired connection installation. Further, because the configuration file edit detection application 130 executes separately from, and monitors files separately from, the file editing applications 128, the file edit detection application 130 does not need to be integrated into each and every potential file editing application 128 in order to automatically propagate configuration changes entered through any file editing application 128.

FIG. 2 is a block diagram illustrating an example workstation 200 that may find user in the system 100 of FIG. 1A. The workstation 200 is identical to the workstations 104 except the workstation 200 stores configuration files locally. Accordingly, the workstation 200 may store, in its own memory, CCS files 132, HTML files 134, image files 136, and/or other configuration files.

FIG. 1B is a block diagram view of a portion of the system 100. As shown in FIG. 1B, each workstation 104 may include a processor 150 and a non-transitory, computer-readable memory 152 storing instructions that, when executed by the processor 150, cause the workstation 104 to perform one or more of the operations, processes, methods, etc. described with respect to the workstation 104 in this disclosure. In particular, the one or more file editing applications 128, the configuration file edit detection application 130, and (in embodiments, such as the embodiment of FIG. 2) a plurality of configuration files may be stored or embodied as instructions and/or data in the memory 152. Further, the functionality of the workstation described with respect to FIGS. 4, 5, and 6 may also be embodied as instructions and/or data in the memory 152.

Similarly, the server 106 may include a processor 154 and a non-transitory, computer-readable memory 156 storing instructions that, when executed by the processor, cause the server 106 to perform one or more of the operations, processes, methods, etc. described with respect to the server 106 in this disclosure. In particular, a terminal device identifier and address cross-listing may be embodied in the memory 156, as may the functionality of the server 106 described in FIGS. 4, 5, and 6.

Still further, each terminal device 108 may include a processor 158 and a non-transitory, computer-readable memory 160 storing instructions that, when executed by the processor, cause the terminal device 108 to perform one or more of the operations, processes, methods, etc. described with respect to the terminal device 108 in this disclosure. In particular, one or more operational configurations of each terminal device 108 may be stored as instructions and data in the memory, as well as functionality and data of the terminal device 108 described with respect to FIGS. 4, 5, and 6.

FIG. 4 is a block diagram illustrating the system 100, with additional functionality illustrated for each of the workstation 104, the server 106, and the terminal device 108. Accordingly, the functionality illustrated in and described with respect to FIG. 4 may be combined with the functionality illustrated in and described with respect to FIGS. 1A-3, as described below.

In some embodiments, the terminal device 108 may be configured to operate in multiple modes-referred to herein as a development mode 402 and a production mode 404. In development mode, operational configuration updates may be quickly propagated to the terminal device 108 for test.

The terminal device 108 may have different operational configurations in production mode 404 and development mode 402. In some embodiments, development mode 402 may include reduced functionality, and therefore reduced processing load, relative to production mode 404. For example, in development mode 402, some functionality, decisions, etc. may be retrieved by the terminal device 108 from the server 106. In another example, where the terminal device 108 is an electronic transaction terminal, the terminal device 108 may be unable to process electronic transactions while in development mode 402, or may be unable to perform one or more aspects of its intended electronic transactions process.

Development mode 402 and production mode 404 may be implemented in a variety of ways. In one approach, the main data storage of the terminal device 108 may be partitioned, with development mode 402 installed on one partition and production mode 404 on another partition. In another approach, production mode 404 and development mode 402 may have separate respective kernels.

In general, the terminal device 108 may be placed in development mode 402 to test configuration changes or certain functionality and in production mode 404 for normal operation. For example, as described herein, a terminal device 108 may be placed in development mode 402 to review, test, and iterate on operational configuration revisions, such as revisions to the user interface of the terminal device 108, and may be placed in production mode 404 once the user confirms a particular operational configuration during testing.

The server 106 and the workstation 104 may cooperate to receive user changes to an operational configuration of one or more terminal devices 108 and to propagate those changes to the one or more terminal devices 108 (e.g., so the user can review those changes while the one or more terminal devices are in development mode 402). For example, in some embodiments, the server 106 may host an integrated development environment (IDE) 406 that may be accessed by the workstation 104 (e.g., via a browser or thin client). The IDE 406 may include a configuration module 408 that includes one or more configuration editing or development programs (e.g., one or more file editing applications 128) through which the developer user may enter configuration changes for a desired one or more terminal devices 108. The configuration editing or development programs may include, for example, one or more programs from which a developer user may define a new operational configuration (e.g., a new user interface (UI) layout, UI flow, correspondence between input element and actions, etc.).

The IDE may further include a change determination module 410 that determines differences between an existing operational configuration of a terminal device 108 and a configuration defined by the user via the configuration module 408. The change determination module 410 may be configured to identify such differences on a difference-by-difference basis (e.g., by comparing the hypothetical output of the terminal device 108 in each configuration), and/or on a file-by-file basis (e.g., by comparing one file to another). For example, to determine a difference-by-difference basis where the operational configuration is a user interface, the change determination module 410 may compare the layout, content, etc. of each interface portion in the “new” configuration to its counterpart interface portions in the existing or other prior configuration.

Based on determined differences, the change determination module 410 may highlight determined differences for the developer user of the workstation 104 and/or determine how to propagate such changes. For example, the change determination module 410 may determine which files need to be revised, repackaged, etc. for ultimate transmission to and execution by the terminal device 108 in order for the terminal device 108 to operate according to the revised operational configuration.

A developer user may access the IDE 406 via a client session 412 in which the developer may define a new user interface configuration 414 and/or a new user experience flow 416 using the configuration module 408. Accordingly, the developer user may instruct mode toggles 418 and configuration changes 420 via the IDE client session 412 for further processing by the server 106.

The server 106 may further include a number of modules for supporting development mode and for converting the developer user's development mode input into production mode operation of the terminal device 108. First, the server 106 may include a mode toggle module 422 that, in response to a mode toggle command from the workstation 104, instructs the terminal device 108 to toggle from production mode to development mode, or from development mode to production mode.

Where the toggle is from production mode to development mode, the server 106 may transmit to the terminal device 108, with the mode toggle instruction, one or more configuration files that the terminal device 108 should use in development mode. Accordingly, a user of the workstation 104 may define an operational configuration in the IDE client session 412, then may transmit a mode toggle command 418 in order to see that configuration tested on the terminal device 108. In response, the server 106 may transmit a mode toggle instruction to the terminal device 108 along with one or more configuration files that embody the configuration received from the workstation 104. The developer user may, via the workstation 104, continue to enter revisions to the operational configuration of the terminal device 108. The server 106 may propagate such changes to the terminal device 108. For example, in some embodiments, the server 106 may propagate such changes automatically, in response to each revision or periodically during an IDE client session 412. Additionally or alternatively, the server 106 may receive a refresh or sync instruction from the workstation 104 and, in response, propagate the present state of the operational configuration defined in the IDE client session 412 to the terminal device 108.

The server 106 may further include development mode logic 424 that provides functionality for testing the terminal device 108 while in development mode 402. For example, where the operational configuration at issue is a user interface configuration, the logic 424 may include user interface flow instructions, such as the behavior of different interface elements and the effect of selecting or using interface elements. In such examples, when a user selects an interface element in development mode 402, the terminal device 108 may transmit the selection to the server 106. In response, the logic 424 may determine the appropriate response to the input, and the server 106 may transmit that response to the terminal device 108. In some embodiments, the response may also include the relevant data for populating the interface or otherwise effecting the response, such that the server 106 is effectively hosting the user interface portion under test. In other embodiments, the terminal device 108 may store the necessary data for populating the interface, and the server 106 may simply supply the interface logic.

Once the developer is completed revising the operational configuration of the terminal device 108, the developer user may confirm the configuration through the IDE client session 412 and, in response, the server 106 may package the operational configuration into one or more files sufficient for the terminal device 108 to implement or execute the revised operational configuration in production mode. For example, as discussed below, the server 106 may package the revised operational configuration into one or more configuration files, and/or into a binary or other executable file.

The server 106 may further include a target configuration file creation module 426 that generates or revises one or more configuration files to reflect the updated operational configuration. The configuration files may be similar to the configuration files described with respect to FIGS. 1A-3. The configuration files created may be based on the differences identified by the change determination module 410, in some embodiments (e.g., the files necessary to embody those revisions).

The server 106 may further include a target executable file creation module 428 that generates one or more executable files to reflect the updated operational configuration. The executable file may be the executable file or files that controls the one or more operational configurations that were revised. For example, where the operational configuration is or includes the user interface, the target executable file creation module 428 may generate an updated user interface control program executable.

The server 106 may further include a stored set (e.g., a database) of previous configuration files 430. The stored previous configuration files 430 may include a plurality of configuration files and executable files respective of a plurality of terminal devices 108 (e.g., each terminal device accessible by the server 106). The server 106 may determine the differences between a present configuration and one or more previous configurations in the previous configuration files 430 (e.g., via the change determination module 410).

The server 106 may further include a debug module 432 configured to output debugging information to the workstation 104 with respect to a configuration under test on a terminal device 108. The debug module 432 may, for example, identify the portion of a configuration file that determines the operational settings being output, utilized, etc. at a given moment on the terminal device 108. For example, the debug module 432 may trace through one or more configuration files or source code files as the terminal device 108 is used and output the relevant file portion to the workstation for debugging. As noted above, the server 106 may receive input information respective of the terminal device 108 in development mode, and may use such input information to determine the appropriate output code to display for the developer user. Further, the debug module 432 may output both operating code and configuration code and files of the terminal device 108, highlighting where changes to operational configuration have been made and where those changes affect other files, even where the server 106 does not receive information respective of the current output or usage of the terminal device 108.

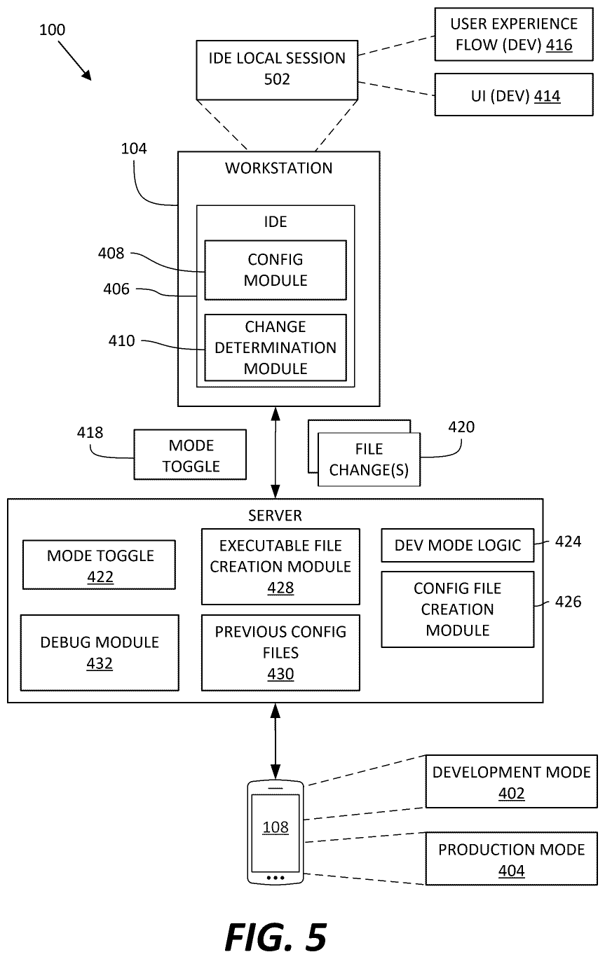

In some embodiments, the debug module may additionally or alternatively be provided on the workstation 104, such as part of a locally-executing IDE as described with respect to FIG. 5, or via a standalone application alongside the applications 128, 130 in FIG. 1.

The IDE 406 and other functionality of the server 106 and workstation 104 provide several mechanisms by which a developer user may update an operational configuration of a terminal device 108. For example, a developer user may directly revise one or more existing configuration files. Additionally or alternatively, the developer user may create one or more new configuration files. Additionally or alternatively, he developer user may design an interface portion or other configuration aspect in a graphical editor, wireframe editor, or other application, and the server may create one or more new configuration files or executable files via the configuration file creation module 426 and executable file creation module 428 based on the user's design or other input.

As noted above, the server 106 may open a connection to a terminal device 108 in response to a developer's identification of the terminal device 108 on a workstation 104. Such a connection may be a websocket or other persistent connection, for example. A persistent connection may advantageously enable the server 106 to automatically and immediately transmit configuration changes to the terminal device when received from the workstation 104. For example, where the developer user is revising a user interface layout via IDE 406, the server may automatically propagate each change (when commanded by the user) to the terminal device 108 without the need to re-establish a network connection with the terminal device 108.

The file editing application 128 and/or configuration file edit detection application 130 illustrated in FIG. 1 may be used in conjunction with one or more of the IDE 406, mode toggle module 422, development mode logic 424, configuration file creation module 426, and executable file creation module 428. For example, the file editing application 128 and/or configuration file edit detection application 130 may be provided in the IDE 406 or otherwise reside on the server 106, and the configuration file network direction 102 may be accessible to the server 106. The user may make operational configuration changes using a file editing application 128 as discussed above, and the server-implemented configuration file edit detection application 130 may monitor the configuration file network direction 102 for file saves. When a newly-saved file is detected, the server 106 may instruct a mode toggle to development mode and transmit the newly-saved file to the terminal device 108.

In a further example, a file editing application 128 and configuration file edit detection application 130 may be used to enter and propagate revisions to a certain type of operational configuration of a given terminal device 108, and the configuration module 408, change determination module 410, and configuration file creation module 426 and/or development mode logic 424 may be used to enter and propagate revisions to a different type of operational configuration on the same terminal device 108. For example, the configuration module 408, change determination module 410, and configuration file creation module 426 and/or development mode logic 424 may be used to propagate changes to operational configurations that can be well-represented by wireframe, graphical representation, or other form that is not a body of text, an image, or another complete file. The file editing application 128 and configuration file edit detection application 130 may be used to propagate operational configurations that are best represented as whole files, in contrast, such as text, images, audio files, etc.

FIG. 5 is a block diagram illustrating the system 100, with additional functionality in each of the workstation 104, the server 106, and the terminal device 108. FIG. 5 illustrates an embodiment in which certain functionality illustrated and described with respect to the server 106 in FIG. 4 are additionally or alternatively instantiated on a workstation 104.

In the embodiment of FIG. 5, the IDE 406, including the configuration module 408 and the change determination module 410, are instantiated on the workstation 104. Accordingly, the workstation may run, and the developer user may use, a local IDE session 502 to perform the operations described above with respect to FIG. 4. Further, in some embodiments, the file editing applications 128 and/or configuration file edit detection application 130 may be provided in the IDE 406, as noted above.

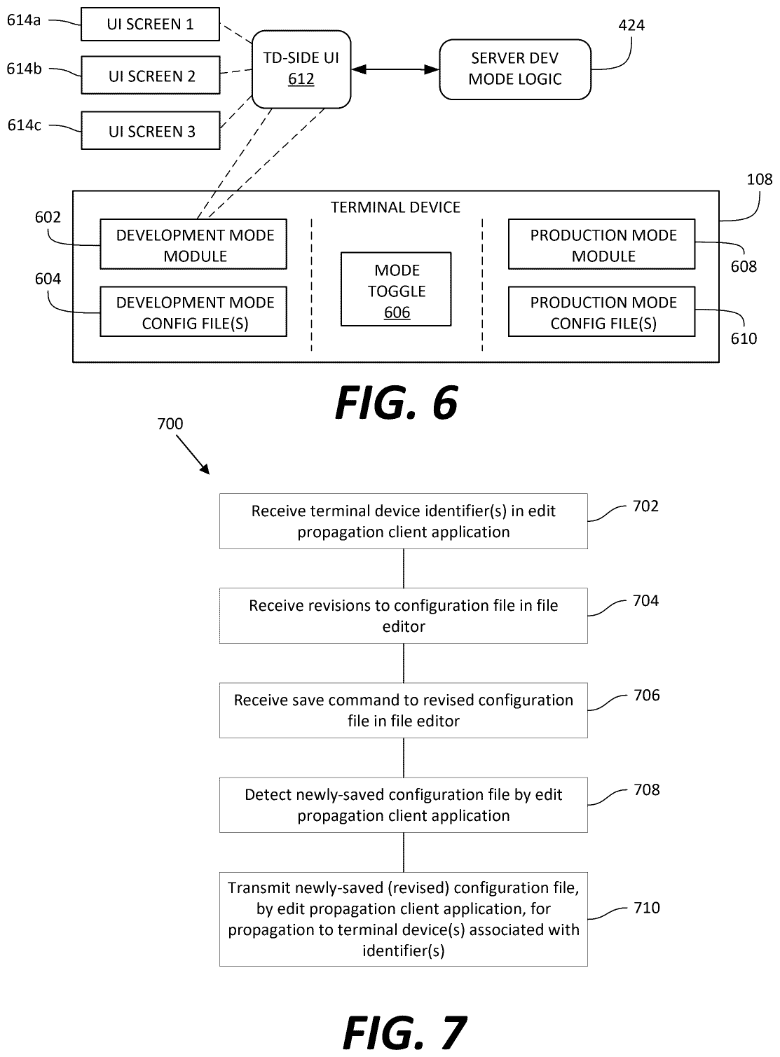

FIG. 6 is a block diagram view of a terminal device 108 (e.g., terminal device 108a). The terminal device may include a development mode module 602, a set of development mode configuration files 604, a mode toggle module 606, a production mode module 608, and a set of production mode configuration files 610.

The development mode module 602 may control the functionality of the terminal device 108 in development mode. Accordingly, the development mode module 602 may include, for example, an operating system or set of executable programs installed specifically for use in development mode. Such programs may include, for example, thin versions or client versions of operating functions or applications, such that the functionality of such functions or applications is reduced relative to production mode and occupies fewer computing resources (less memory and less processing power) for storage and execution. Such thin or client applications may rely, at least in part, on the server 106 (see FIGS. 4 and 5) to provide certain functionality. The functionality of the development mode module 602 may be sufficient to test desired operational configurations. For example, the development mode module 602 may include a web browser, a wireframe viewer, etc.

The development mode configuration files 604 may include one or more configuration files being tested in development mode, and/or one or more configuration files otherwise needed to operate in development mode. The development mode configuration files 604 may be volatile, in some embodiments, such that the development mode configuration files 604 are cleared from storage when development mode is not in use to reduce the memory demand of development mode.

The mode toggle module 606 may, in response to commands from the server 106, from a user input directly on the terminal device 108, or from another computing device, switch the terminal device 108 from development mode to production mode, or from production mode to development mode. The mode toggle module 606 may, in some embodiments, be implemented as functionality in both the development mode module 602 and the production mode module 608, such that it may be invoked when in either mode. Further, the mode toggle module 606 may be implemented as further functionality in startup code of the terminal device 108 (e.g., BIOS or equivalent) that can select a mode upon boot-up of the terminal device 108.

The production mode module 608 may control the functionality of the terminal device 108 in production mode. Accordingly, the production mode module 608 may include, for example, an operating system or set of executable programs installed specifically for use in production mode. Such programs may include a desired operating configuration, such as one that has been tested and finalized in development mode. For example, where the terminal device 108 is an electronic transaction terminal, production mode may include functionality for executing or facilitating electronic transactions, such as reading transaction information from a card or computing device, decoding such information, transmitting such information to a server for transaction clearance, etc.

The production mode configuration files 610 may include one or more configuration files for use in production mode, and/or one or more configuration files otherwise needed to operate in production mode. The production mode configuration files 610 may be persistent, in some embodiments, such that they are maintained in storage in between power cycles of the terminal device 108.

As noted above, when in development mode, the terminal device 108 may receive certain operational support from a server. For example, the terminal device user interface 612 may receive support from (e.g., may be hosted in part or in entirety by) server development mode logic 424. For example, the server development mode logic 424 may receive user input in a UI portion under test in development mode and may command or provide the relevant response to the UI 612. In an example embodiment, the UI 612 may include three interface screens 614a, 614b, 614c. Interface screen 614a may include a first input element that, when selected, results in a navigation to interface screen 614b. Similarly, interface screen 614b may include a second input element that, when selected, results in a navigation to interface screen 614c. When a user selects the first input element, the terminal device may transmit the input to the server development mode logic 424. In response, the server development mode logic 424 may determine that the UI should navigate to UI screen 614b, and may transmit an instruction to the terminal device 108 to navigate to UI screen 614b and/or data respective of UI screen 614b. When a user selects the second input element, the terminal device 108 may transmit the input to the server development mode logic 424. In response, the server development mode logic 424 may determine that the UI should navigate to UI screen 614c, and may transmit an instruction to the terminal device 108 to navigate to UI screen 614c and/or data respective of UI screen 614c.

FIGS. 7, 8, and 9 below will describe an approach for propagating operational configuration updates to terminal devices from the perspectives of the workstation 104, server 106, and terminal device 108, respectively. Accordingly, the methods 700, 800, 900 of FIGS. 7, 8, and 9 may be performed together, in some embodiments. Further, in some embodiments, the methods 700, 800, 900 may be performed in association with a development mode of a terminal device 108, As that development mode is discussed with respect to FIGS. 4-6.

FIG. 7 is a flow chart illustrating an example computer-implemented method 700 of performing remote device updates from a workstation. The method 700, or one or more aspects of the method 700, may be performed by a workstation, such as the workstation 104.

The method 700 may include, at block 702, receiving one or more terminal device identifiers in an edit propagation client application, such as the configuration file edit detection application 130. The terminal identifiers may be respective of terminal devices to which a developer user may wish a common operational configuration to be propagated. Block 702 may additionally include, in some embodiments, receiving metadata information respective of target operational configuration files that are to be monitored for new file saves. Such metadata may include, for example, file type, file extension, revising/saving user, file name, file directory, etc.

The method 700 may further include, at block 704, receiving revisions to one or more configuration files in a file editor (e.g., a file editing application 128). The revisions may be revisions to one or more configuration files directly (e.g., direct revisions to code in an HTML file, for example), may be creation of a new operational configuration file, and/or may be input in a configuration creator that is then translated into or can be translated into an operational configuration file.

In some embodiments, block 704 may include receiving a request from the user for an existing (e.g., original) operational configuration file from a user and, in response, retrieving the existing operational configuration file from storage (e.g., local storage or network storage) and providing the file to the user for editing. Block 704 may thus include receiving the user's revisions to the retrieved existing operational configuration file.

The method 700 may further include, at block 706, receiving a save command to a revised configuration file in the file editor. The save command may have been entered by a user in order to save an operational configuration file on which the user was working in order to define a new operational configuration.

The method 700 may further include, at block 708, detecting a newly-saved configuration file by the edit propagation client application. Block 708 may include, for example, monitoring a file system in which operational configuration files are saved (a local file system and/or a network file system) for newly-saved, or updated saved, files that match metadata previously indicated in operation 702.

The method 700 may further include, at block 710, transmitting the newly-saved, revised one or more configuration files, by the edit propagation client application, for propagation to the one or more terminal devices associated with the received one or more identifiers. Block 710 may include, for example, transmitting the newly-saved files to the one or more terminal devices with an instruction for the one or more terminal devices to replace the existing counterpart configuration file with the newly-saved revised configuration file.

Block 710 may include, in some embodiments, transmitting a notification of a revision to a server. The notification may include the one or more device identifiers received at block 702 and the one or more revised configuration files. In turn, the server may propagate the configuration files to the relevant terminal devices.

In some embodiments, the method 700 may be applied with respect to display configuration or user interface configuration files. Such display configuration files may include, for example, CCS files, HTML files, and/or image files.

In some embodiments, method 700 may be performed to propagate a sequence or series of operational configuration revisions to the terminal device 108. For example, blocks 708 and 710 may be performed each time a new file save (of a relevant configuration file) occurs so that the terminal device 108 is updated each time a developer user saves the configuration file being edited, such that the developer user can save a file and observe changes to the terminal device from the previous configuration, if the developer has access to the terminal device during the performance of method 700. In other words, each time a revision is entered and a file is saved, a notification may be transmitted according to block 710.

In some embodiments, the method 700 may be performed by multiple workstations, with respect to the same or different terminal devices. For example, a first workstation may provide changes to a first type of operational configuration (e.g., a user interface configuration), and a second workstation may provide changes to a second type of operational configuration (e.g., a security configuration) at substantially the same time. Such different configurations may be respective of different file types. In such an embodiment, the first and second workstations may communicate with the same server or with different servers.

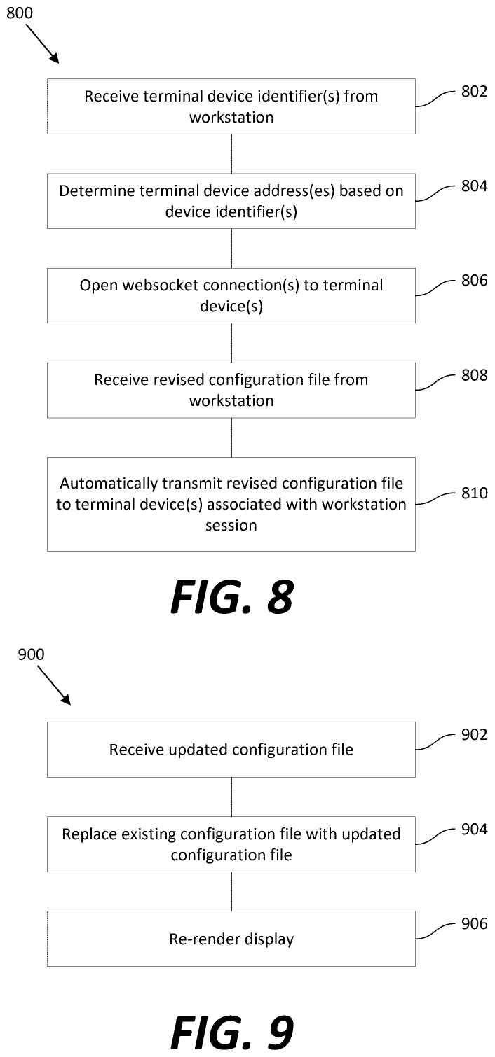

FIG. 8 is a flow chart illustrating an example computer-implemented method 800 of performing remote device updates by a server. The method 800, or one or more aspects of the method 800, may be performed by a server, such as the server 106.

The method 800 may include, at block 802, receiving one or more terminal device identifiers from a workstation. The terminal identifiers may be respective of terminal devices to which common operational configuration updates are to be propagated.

The method 800 may further include, at block 804, determining one or more respective device addresses based on the device identifiers received at block 802. Block 802 may include, for example, cross-referencing a lookup table of device identifiers and device addresses.

The method 800 may further include, at block 806, opening (e.g., establishing) a websocket or other persistent connection with each terminal device at the device addresses determined in block 804. In some embodiments, opening the one or more connections may be performed in response to block 804 and/or block 802. Opening such a persistent connection may enable quick and reliable propagation of configuration changes and updates (e.g., configuration files). Further, a websocket connection between a server and each terminal device may permit indirect communication between a workstation (in communication with the server performing the method 800) and the terminal device in environments in which such terminals may not permitted direct access to local computing devices for security or other purposes. In particular, by routing communications through the server performing the method 800, security precautions may be taken at a single access point (the server) as to all terminal devices, instead of requiring the necessary security precautions at each and every workstation that may be used by a developer.

The method 800 may further include, at block 808, receiving a revised configuration file from the workstation. The revised configuration file may be different from a configuration file present on the one or more terminal devices identified in block 802. In some embodiments, the revised configuration file may be received with the one or more terminal device identifiers (e.g., blocks 802, 808 may be performed in tandem).

The method 800 may further include, at block 810, automatically transmitting the revised configuration file to the one or more terminal devices at the device addresses determined in block 804. Block 810 may be performed in response to block 808 and/or block 802. Block 810 may include instructing the one or more terminal devices to replace an existing configuration file with the revised configuration file. In some embodiments, where rebooting or refreshing an aspect of the terminal device is necessary to implement the contents of the revised configuration file, block 810 may also include an instruction for the terminal device to reboot or refresh. For example, where the operational configuration is a user interface configuration, block 810 may include transmitting an instruction to the terminal device to refresh its display or other user interface output after installing or saving the revised configuration file.

In some embodiments, the method 800 may be performed with respect to multiple types of operational configurations for the same terminal device. For example, revisions to a first type of operational configuration (e.g., a user interface configuration) may be provided and propagated, as well as changes to a second type of operational configuration (e.g., a security configuration) at substantially the same time. Such different configurations may be respective of different file types. The revisions to the first and second configuration types may be received from the same workstation, or from separate workstations.

In some embodiments, the operations of the method 800 may be performed with the relevant one or more terminal devices in a development mode. Once the method 800 is concluded, the terminal device may be switched to a production mode. Furthermore, the final desired version of the operational configuration can be prepared for production mode implementation as described with respect to block 1014 and the executable file creation module 428, in some embodiments.

FIG. 9 is a flow chart illustrating an example computer-implemented method 900 of receiving remote device updates by a terminal device. The method 900, or one or more aspects of the method 900, may be performed by a terminal device such as a terminal device 108.

The method 900 may include, at block 902, receiving an updated configuration file. The updated configuration file may be received from a server (e.g., via a websocket or other persistent connection). The updated configuration file may be different from an existing configuration file stored on the terminal device. The updated configuration file may be a user interface configuration file, for example. In some embodiments, block 902 may also include receiving an instruction to refresh or reboot one or more aspects of the terminal device (e.g., the portions controlled by or otherwise affected by the updated configuration file).

The method 900 may further include, at block 904, replacing the existing configuration file with the updated configuration file. Block 904 may include deleting the existing configuration file, archiving the existing configuration file in storage of the terminal device, and/or transmitting the existing configuration file to the server to be archived by the server.

The method 900 may further include, at block 906, re-rendering the display and/or other user interface aspect of the terminal device. Block 906 may be performed in response to blocks 902 and/or 904, in some embodiments. Block 906 may be performed without user instruction at the terminal device.

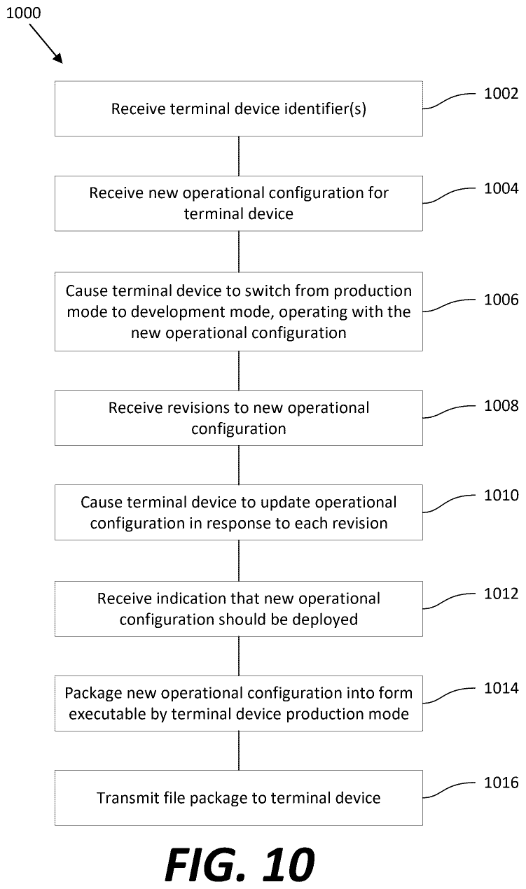

FIGS. 10, 11, and 12 will describe an approach for propagating operational configuration updates to terminal devices from the perspectives of the server 106, terminal device 108, and workstation 104, respectively. Accordingly, the methods 1000, 1100, 1200 of FIGS. 10, 11, and 12 may be performed together, in some embodiments.

The approach illustrated in and described with respect to FIGS. 10-12 is in addition to, not mutually exclusive of, the approach illustrated in and described with respect to FIGS. 7-9. Accordingly, the approach illustrated in and described with respect to FIGS. 10-12 may be performed in conjunction with the approach of FIGS. 7-9, in some embodiments, with some updates being performed according to FIGS. 7-9 and other updates performed according to FIGS. 10-12 across an overlapping set or the same set of workstations, servers, and terminal devices.

FIG. 10 is a flow chart illustrating an example computer-implemented method 1000 of performing remote device updates with a server. The method 1000, or one or more aspects of the method 1000, may be performed by a server, such as the server 106, in some embodiments.

The method 1000 may include, at block 1002, receiving one or more device identifiers respective of one or more terminal devices. The device identifiers may be received from a workstation, for example. Block 1002 may be substantially similar to block 802, in some embodiments. Further, in some embodiments, block 1002 may include determining a terminal device address, as described with respect to block 804, and opening a network connection to the terminal device (e.g., a websocket or other persistent connection), as described with respect to block 806.

The method 1000 may further include, at block 1004, receiving a new operational configuration for the terminal devices indicated at block 1002. The new operational configuration may be received by a developer user revising one or more existing configuration files, creating one or more new configuration files, and/or by generating the output or result of a new configuration (e.g., designing an interface portion in a graphical editor). In some embodiments, block 1004 may include receiving one or more revised configuration files, as described with respect to block 808 (e.g., where the workstation executes a local IDE).

In some embodiments, blocks 1002 and 1004 may be performed via an IDE hosted by a server performing the method 1000, as described with respect to FIG. 4. In other embodiments, blocks 1002 and 1004 may be performed via electronic communications with the workstation, after the workstation has defined the new operational configuration on a locally-executing IDE, as described with respect to FIG. 5.

The method 1000 may further include, at block 1006, causing the terminal device to switch from production mode to development mode, operating with the new operational configuration. Block 1006 may include transmitting a mode switch or mode toggle instruction to the terminal device. Block 1006 may be performed in response to receiving a mode toggle command from the workstation.

Block 1006 may include transmitting one or more operational configuration files to the terminal device for execution or performance in development mode. In some embodiments, block 1006 may include determining differences between an existing operational configuration of the terminal device and the new operational configuration, and transmitting the differences to the terminal device. The differences may be transmitted in the form of updated configuration files which reflect or embody the differences. Additionally or alternatively, the differences may be transmitted in the form of instructions to alter (rather than replace) configuration files stored on the terminal device, in response to which the terminal device may edit the files automatically.

The method 1000 may further include, at block 1008, receiving revisions to the new operational configuration. For example, the developer user may continue to edit or create the configuration received at block 1004. In some embodiments, block 1008 may include receiving one or more further revised configuration files, as described with respect to block 808 (e.g., where the workstation executes a local IDE).

The method 1000 may further include, at block 1010, causing the terminal device to update its operational configuration in response to each revision. Block 1010 may include transmitting one or more operational configuration files to the terminal device for execution or performance in development mode, or performing other operations described above with respect to block 1006.

The method 1000 may further include, at block 1012, receiving an indication that the new operational configuration should be deployed and, at block 1014, in response to the indication at block 1012, packaging or otherwise formatting the new operational configuration into a form executable or otherwise usable by the terminal device in production mode. Such packaging may include generating or revising one or more configuration files, and/or generating a binary or other executable file as discussed above with respect to FIG. 4.

The method 1000 may further include, at block 1016, transmitting the file package to the terminal device. The transmission at block 1016 may include an instruction to switch back to production mode and to install or otherwise store the file package so that the new operational configuration is executed or performed in production mode by the terminal device. In some embodiments, blocks 1014 and 1016 may include automatically transmitting a received, revised configuration file, as described above with respect to block 810.

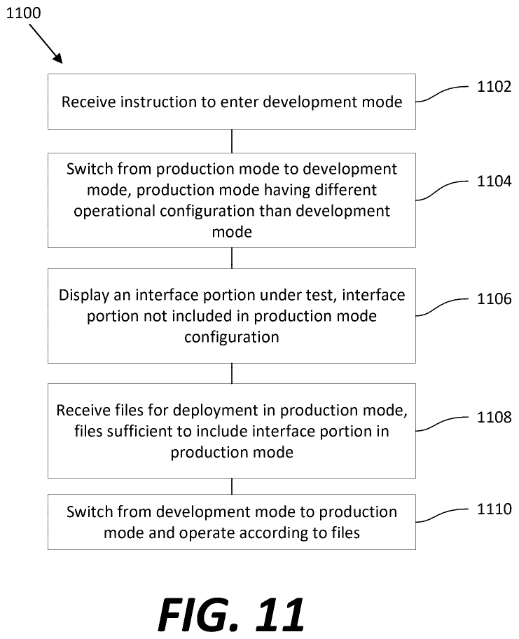

FIG. 11 is a flow chart illustrating an example computer-implemented method 1100 of performing remote device updates by a terminal device. The method 1100, or one or more aspects of the method 1100, may be performed by a terminal device, such as a terminal device 108, in some embodiments.

The method 1100 may include, at block 1102, receiving an instruction to enter development mode. The instruction may be received from a server, in some embodiments. The instruction may include one or more files intended for use in development mode. For example, the one or more files may include a configuration for a user interface portion under test.

The method 1100 may further include, at block 1104, switching from production mode to development mode, where production mode has a different operational configuration than development mode, in response to the instruction of block 1102. Switching from production mode to development mode may include altering a register or other non-volatile store of a mode setting (e.g., as part of the BIOS or other startup portion of the terminal device's operations) and restarting the terminal device.

The method 1100 may further include, at block 1106, displaying an interface portion under test, where the interface portion is not included in the production mode operational configuration. The interface portion may be respective of the files received at block 1102. Block 1106 may include refreshing the user interface to display the interface portion under test after installing or otherwise storing the files received at block 1102.

In some embodiments, block 1106 may be performed repeatedly to test different versions of, or to test different alterations to, the interface portion under test.

The method 1100 may further include, at block 1108, receiving one or more files for deployment in production mode, the files sufficient to include the interface portion in the production mode operational configuration. The files may be or may include, for example, one or more configuration files or a binary or other executable file.

The method 1100 may further include, at block 1110, switching from development mode to production mode and operating according to the one or more files received at block 1108. In some embodiments, block 1108 may include storing the files received at block 1108, installing the files received at block 1108, or otherwise causing the files received at block 1108 to be operable in production mode.

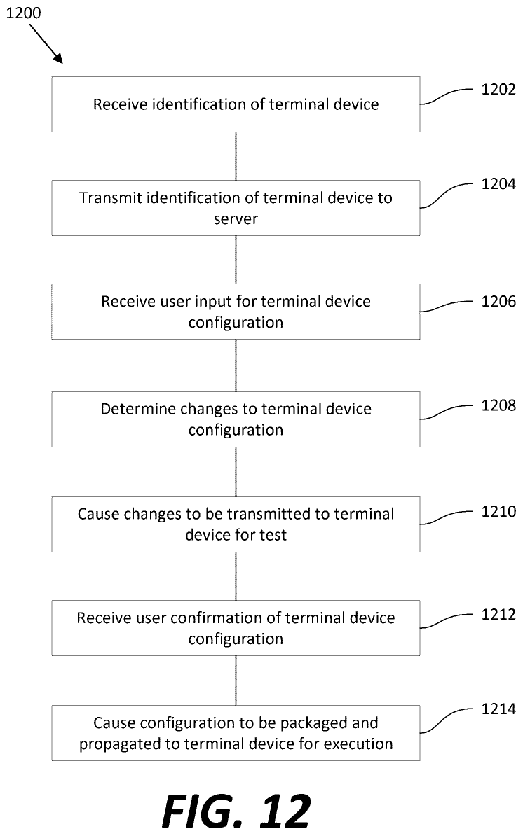

FIG. 12 is a flow chart illustrating an example computer-implemented method 1200 of performing remote device updates with a workstation. The method 1200, or one or more aspects of method 1200, may be performed by a workstation, such as a workstation 104, in some embodiments.

The method 1200 may include, at block 1202, receiving an identification of a terminal device and, at block 1204, transmitting the terminal device identifier to a server. The identifier may be received through an IDE executing locally on the workstation or hosted by the server and executing on a client on the workstation. Blocks 1202 and 1204 may be substantially similar to block 702, in embodiments.

The method 1200 may further include, at block 1206, receiving user input for the terminal device's configuration. The user's input may be in one or more file editors or configuration editors, for example. Accordingly, block 1206 may be substantially similar to block 706, in some embodiments, but implemented through an IDE, for example.

The method may further include, at block 1208, determining one or more changes to the terminal device configuration after the user input at block 1206. Changes may be determined as described with respect to the change determination module 410 above. Blocks 706 and 708 may be an example implementation of block 1208, in some embodiments. That is, receiving a save command (block 706) and detecting a newly-saved file (block 708) may serve as an approach for determining one or more changes to the terminal device configuration.

The method 1200 may further include, at block 1210, causing the changes to be transmitted to the terminal device for testing. For example, the workstation may transmit a configuration propagation instruction to the server to cause the server to transmit the changes to the terminal device. Alternatively, block 1210 may be substantially similar to block 710, in some embodiments, e.g., where a configuration file is transmitted instead of a configuration propagation instruction.

The method 1200 may further include, at block 1212, receiving a user confirmation of the terminal device configuration. The user confirmation may be received in the IDE, for example, and may indicate that the user wishes for the terminal device to operate in production mode with the operational configuration most recently tested.

The method 1200 may further include, at block 1214, causing the confirmed configuration to be packaged and propagated to the terminal device for execution. In some embodiments, the instruction at block 1212 may also cause the confirmed configuration to be packaged and propagated to the terminal device for execution. In some embodiments, a separate command may be issued by the workstation. In some embodiments, the workstation may perform the packaging of the operational configuration into one or more files.

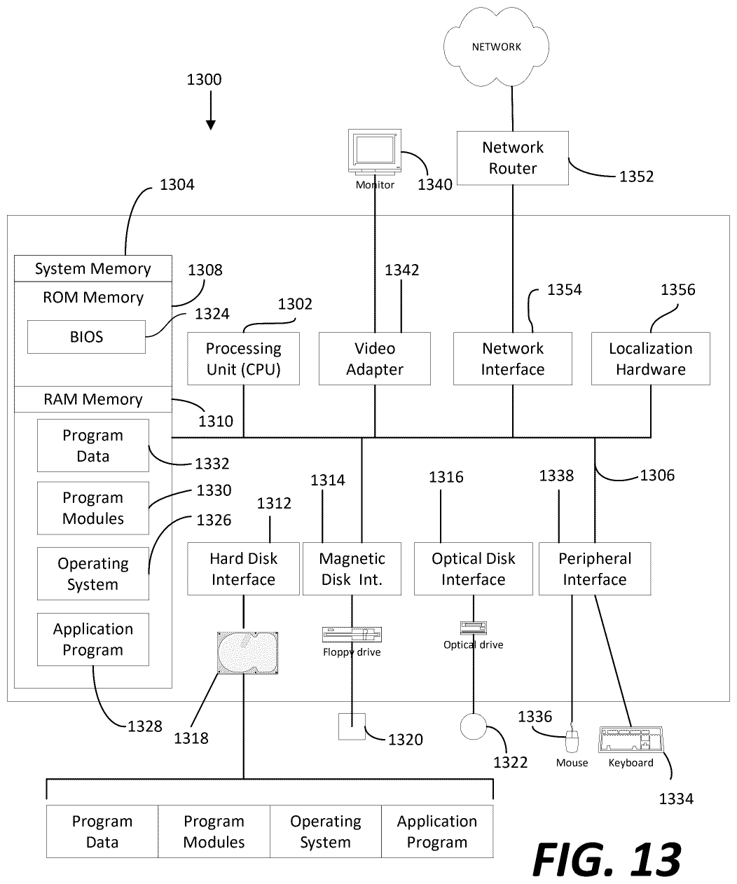

FIG. 13 is a block diagram of an example computing system 1300, such as a desktop computer, laptop, smartphone, tablet, or any other such device having the ability to execute instructions, such as those stored within a non-transient, computer-readable medium. Furthermore, while described and illustrated in the context of a single computing system 1300, those skilled in the art will also appreciate that the various tasks described hereinafter may be practiced in a distributed environment having multiple computing systems 1300 linked via a local or wide-area network in which the executable instructions may be associated with and/or executed by one or more of multiple computing systems 1300.

In its most basic configuration, computing system environment 1300 typically includes at least one processing unit 1302 and at least one memory 1304, which may be linked via a bus 1306. Depending on the exact configuration and type of computing system environment, memory 1304 may be volatile (such as RAM 1310), non-volatile (such as ROM 1308, flash memory, etc.) or some combination of the two. Computing system environment 1300 may have additional features and/or functionality. For example, computing system environment 1300 may also include additional storage (removable and/or non-removable) including, but not limited to, magnetic or optical disks, tape drives and/or flash drives. Such additional memory devices may be made accessible to the computing system environment 1300 by means of, for example, a hard disk drive interface 1312, a magnetic disk drive interface 1314, and/or an optical disk drive interface 1316. As will be understood, these devices, which would be linked to the system bus 1306, respectively, allow for reading from and writing to a hard disk 1318, reading from or writing to a removable magnetic disk 1320, and/or for reading from or writing to a removable optical disk 1322, such as a CD/DVD ROM or other optical media. The drive interfaces and their associated computer-readable media allow for the nonvolatile storage of computer readable instructions, data structures, program modules and other data for the computing system environment 1300. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 1300.

A number of program modules may be stored in one or more of the memory/media devices. For example, a basic input/output system (BIOS) 1324, containing the basic routines that help to transfer information between elements within the computing system environment 1300, such as during start-up, may be stored in ROM 1308. Similarly, RAM 1310, hard drive 1318, and/or peripheral memory devices may be used to store computer executable instructions comprising an operating system 1326, one or more applications programs 1328, other program modules 1330, and/or program data 1332. Still further, computer-executable instructions may be downloaded to the computing environment 1300 as needed, for example, via a network connection. The applications programs 1328 may include, for example, a browser.

An end-user may enter commands and information into the computing system environment 1300 through input devices such as a keyboard 1334 and/or a pointing device 1336. While not illustrated, other input devices may include a microphone, a joystick, a game pad, a scanner, etc. These and other input devices would typically be connected to the processing unit 1302 by means of a peripheral interface 1338 which, in turn, would be coupled to bus 1306. Input devices may be directly or indirectly connected to processor 1302 via interfaces such as, for example, a parallel port, game port, firewire, or a universal serial bus (USB). To view information from the computing system environment 1300, a monitor 1340 or other type of display device may also be connected to bus 1306 via an interface, such as via video adapter 1342. In addition to the monitor 1340, the computing system environment 1300 may also include other peripheral output devices, not shown, such as speakers and printers.

The computing system environment 1300 may also utilize logical connections to one or more computing system environments. Communications between the computing system environment 1300 and the remote computing system environment may be exchanged via a further processing device, such a network router 1348, that is responsible for network routing. Communications with the network router 1348 may be performed via a network interface component 1344. Thus, within such a networked environment, e.g., the Internet, World Wide Web, LAN, or other like type of wired or wireless network, it will be appreciated that program modules depicted relative to the computing system environment 1300, or portions thereof, may be stored in the memory storage device(s) of the computing system environment 1300.

The computing system environment 1300 may also include localization hardware 1346 for determining a location of the computing system environment 1300. In embodiments, the localization hardware 1346 may include, for example only, a GPS antenna, an RFID chip or reader, a WiFi antenna, or other computing hardware that may be used to capture or transmit signals that may be used to determine the location of the computing system environment 1300. Data from the localization hardware 1346 may be included in a callback request or other user computing device metadata in the methods of this disclosure.

The computing system 1300, or one or more portions thereof, may embody a workstation 104, server 106, and/or terminal device 108, in some embodiments.

In a first aspect of the present disclosure, a computer-implemented method is provided that includes receiving, by a computing system, a selection of a terminal device having an existing operational configuration and capable of operating in a development mode and a production mode, receiving, by the computing system, a new operational configuration for the terminal device, causing, by the computing system, the terminal device to enter development mode with the new operational configuration, receiving, by the computing system, an indication that the new operational configuration should be deployed, and in response to the indication, by the computing system, formatting the new operational configuration into one or more files usable by the terminal in production mode, and causing the one or more files to be transmitted to the terminal with an instruction for the terminal device to enter production mode operating according to the one or more files.

In an embodiment of the first aspect, the existing operational configuration and the new operational configuration are both user interface configurations, and the method further comprises, while the terminal device is in development mode with the new operational configuration, receiving, from the terminal device, a user selection of an interface element, and transmitting, to the terminal device, an interface flow responsive to the user selection.

In an embodiment of the first aspect, the method further includes determining, by the computing system, differences between the existing operational configuration and the new operational configuration, wherein formatting the new operational configuration into one or more files is according to the determined differences.

In an embodiment of the first aspect, the computing system comprises a workstation configured to receive operational configuration revisions from a developer and a server in communication with the workstation.

In an embodiment of the first aspect, operation in development mode requires fewer computing resources by the computing system than does operation in production mode.

In an embodiment of the first aspect, the method further includes archiving, by the computing system, the existing operation configuration.

In an embodiment of the first aspect, receiving the new operational configuration for the terminal device comprises receiving a sequence of new operational configurations, and causing the terminal device to enter development mode with the new operational configuration comprises, in response to each respective new operational configuration of the sequence of new operational configurations, causing the terminal device to enter development mode with the respective new operational configuration.

In a second aspect of the present disclosure, a server computing system is provided that includes a processor and a non-transitory, computer-readable memory storing instructions that, when executed by the processor, cause the server computing system to perform operations comprising transmitting, to a terminal device, an instruction for the terminal to enter a development mode, receiving a user interface portion for test on the terminal device, hosting the user interface portion for display on the terminal device while the terminal device is in development mode, receiving a confirmation of the user interface portion, and in response to the confirmation, packaging and transmitting the user interface portion to the terminal device for installation on the terminal device.

In an embodiment of the second aspect, receiving the user interface portion for test comprises receiving the user interface portion from a user computing device, or retrieving the user interface portion from a set of stored user interface portions on the server.

In an embodiment of the second aspect, hosting the user interface portion comprises receiving an interface input from the terminal device and, in response, determining an interface navigation, and instructing the terminal device to perform the interface navigation according to interface data stored on the terminal device, or transmitting interface data to the terminal device respective of the interface navigation.

In an embodiment of the second aspect, packaging the user interface portion comprises generating an executable file.

In an embodiment of the second aspect, the operations further include comparing the user interface portion to a prior interface, and determining how the user interface portion differs from the prior interface, wherein packaging the user interface portion is according to how the user interface portion differs from the prior interface.

In an embodiment of the second aspect, the operations further include hosting an integrated development environment (IDE), wherein receiving the user interface portion comprises receiving the user interface portion via the IDE from a workstation in electronic communication with the server computing device.

In an embodiment of the second aspect, the operations further include establishing a persistent network connection with the terminal device, wherein hosting the user interface portion for display on the terminal device while the terminal device is in development mode is via the persistent network connection and transmitting the user interface portion to the terminal device for installation on the terminal device is via the persistent network connection.

In a third aspect of the present disclosure, a computing transaction terminal is provided that includes a processor and a non-transitory, computer-readable memory storing instructions that, when executed by the processor, cause the computing transaction terminal to perform operations including receiving an instruction from a server to enter development mode, in response to the instruction, switching from a production operational mode to a development operational mode, wherein the production operational mode has a different operational configuration than the development operational mode, displaying an interface portion under test while in development mode, wherein the interface portion is not included in the operational configuration of the production development mode, receiving an updated one or more files from the server, the updated one or more files sufficient to include the interface portion in an updated production mode operational configuration, and switching from the development operational mode to the production operational mode according to the one or more files.

In an embodiment of the third aspect, the one or more files comprises an executable file.

In an embodiment of the third aspect, operation in development mode requires fewer computing resources by the computing transaction terminal than does operation in production mode.

In an embodiment of the third aspect, the terminal is a payment terminal.

In an embodiment of the third aspect, the operations further include receiving user input in the interface portion under test while in development mode, transmitting the user input to the server, receiving, from the server, an interface navigation responsive to the user input, and displaying the interface navigation. In a further embodiment of the third aspect, displaying the interface navigation includes retrieving a further interface portion from a storage of the computing transaction terminal, or receiving a further interface portion from the server.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A computer-implemented method comprising:
receiving, by a computing system, a selection of a terminal device having an existing operational configuration and capable of operating in a development mode and a production mode;
receiving, by the computing system, a new operational configuration for the terminal device;
causing, by the computing system, the terminal device to enter development mode with the new operational configuration;
receiving, by the computing system, an indication that the new operational configuration should be deployed; and
in response to the indication, by the computing system, formatting the new operational configuration into one or more files usable by the terminal in production mode, and causing the one or more files to be transmitted to the terminal with an instruction for the terminal device to enter production mode operating according to the one or more files.

2. The computer-implemented method of claim 1, wherein:
the existing operational configuration and the new operational configuration are both user interface configurations; and
the method further comprises, while the terminal device is in development mode with the new operational configuration:
receiving, from the terminal device, a user selection of an interface element; and
transmitting, to the terminal device, an interface flow responsive to the user selection.

3. The computer-implemented method of claim 1, further comprising:
determining, by the computing system, differences between the existing operational configuration and the new operational configuration;
wherein formatting the new operational configuration into one or more files is according to the determined differences.

4. The computer-implemented method of claim 1, wherein the computing system comprises a workstation configured to receive operational configuration revisions from a developer and a server in communication with the workstation.

5. The computer-implemented method of claim 1, wherein operation in development mode requires fewer computing resources by the computing system than does operation in production mode.

6. The computer-implemented method of claim 1, further comprising archiving, by the computing system, the existing operation configuration.

7. The computer-implemented method of claim 1, wherein:
receiving the new operational configuration for the terminal device comprises receiving a sequence of new operational configurations; and
causing the terminal device to enter development mode with the new operational configuration comprises, in response to each respective new operational configuration of the sequence of new operational configurations, causing the terminal device to enter development mode with the respective new operational configuration.

8. A server computing system comprising:
a processor; and
a non-transitory, computer-readable memory storing instructions that, when executed by the processor, cause the server computing system to perform operations comprising:
transmitting, to a terminal device, an instruction for the terminal to enter a development mode;
receiving a user interface portion for test on the terminal device;
hosting the user interface portion for display on the terminal device while the terminal device is in development mode;
receiving a confirmation of the user interface portion; and
in response to the confirmation, packaging and transmitting the user interface portion to the terminal device for installation on the terminal device.

9. The server computing system of claim 8, wherein receiving the user interface portion for test comprises:
receiving the user interface portion from a user computing device; or
retrieving the user interface portion from a set of stored user interface portions on the server.

10. The server computing system of claim 8, wherein hosting the user interface portion comprises:
receiving an interface input from the terminal device and, in response, determining an interface navigation, and:
instructing the terminal device to perform the interface navigation according to interface data stored on the terminal device; or
transmitting interface data to the terminal device respective of the interface navigation.

11. The server computing system of claim 8, wherein packaging the user interface portion comprises generating an executable file.

12. The server computing system of claim 8, wherein the operations further comprise:
comparing the user interface portion to a prior interface; and
determining how the user interface portion differs from the prior interface;
wherein packaging the user interface portion is according to how the user interface portion differs from the prior interface.

13. The server computing system of claim 8, wherein the operations further comprise:
hosting an integrated development environment (IDE);
wherein receiving the user interface portion comprises receiving the user interface portion via the IDE from a workstation in electronic communication with the server computing device.

14. The server computing system of claim 8, wherein the operations further comprise:
establishing a persistent network connection with the terminal device;
wherein hosting the user interface portion for display on the terminal device while the terminal device is in development mode is via the persistent network connection and transmitting the user interface portion to the terminal device for installation on the terminal device is via the persistent network connection.

15. A computing transaction terminal comprising:
a processor; and
a non-transitory, computer-readable memory storing instructions that, when executed by the processor, cause the computing transaction terminal to perform operations comprising:
receiving an instruction from a server to enter development mode;
in response to the instruction, switching from a production operational mode to a development operational mode, wherein the production operational mode has a different operational configuration than the development operational mode;
displaying an interface portion under test while in development mode, wherein the interface portion is not included in the operational configuration of the production development mode;
receiving an updated one or more files from the server, the updated one or more files sufficient to include the interface portion in an updated production mode operational configuration; and
switching from the development operational mode to the production operational mode according to the one or more files.

16. The computing transaction terminal of claim 15, wherein the one or more files comprises an executable file.

17. The computing transaction terminal of claim 15, wherein operation in development mode requires fewer computing resources by the computing transaction terminal than does operation in production mode.

18. The computing transaction terminal of claim 15, wherein the terminal is a payment terminal.

19. The computing transaction terminal of claim 15, wherein the operations further comprise:
receiving user input in the interface portion under test while in development mode;
transmitting the user input to the server;
receiving, from the server, an interface navigation responsive to the user input; and
displaying the interface navigation.

20. The computing transaction terminal of claim 19, wherein displaying the interface navigation comprises:
retrieving a further interface portion from a storage of the computing transaction terminal; or
receiving a further interface portion from the server.
